(19) United States
(12) Patent Application Publication
(10) Pub. No.: US 2011/0070920 A1
(43) Pub. Date: Mar. 24, 2011

(54) METHOD FOR A PHONE WITH CONTENT PROJECTOR

(76) Inventor: Aasim M. Saied, (US)

(21) Appl. No.: 12/566,617

(22) Filed: Sep. 24, 2009

(51) Int. Cl. H04M 1/00

(52) U.S. Cl. 455/552.1; 455/556.1

(57) ABSTRACT

Our method covers a phone with a content projector that has two SIM cards, two cameras and 01 SD card. Our method can project movie content from an SD card loaded movie on the projector.

### BACKGROUND

### Prior Art

This method for a phone with content projector relates to light transmitted from an illuminating system modulated by liquid crystal or the like information (image signals), and the modulated light is projected onto a screen, thereby achieving image display.

Incidentally, when light emitted from the illuminating system is applied to the liquid crystal light valves, the polarizers of the liquid produces heat. In this case the temperature of the polarizers is sometimes increased to a high temperature of about 80 C. This is because the light that is not transmitted by the polarizers is absorbed by the polarizers.

Several inventions were made to solve the problem on how to project an image onto a screen, the idea of a LCD projector exists since 1968, when Gene Dolgoff first thought about the idea of having an LCD projector, it took him several years to get the first prototype to work and he finally filed the U.S. Pat. No. 5,012,274.

Cell phone technology was being used by billions of people and it was confined to a small screen. And there was a need for having a better infrastructure of 2G to 3G improved the technology where people could stream video.

We saw people were not enjoying the mobile entertainment. Now people will be apple to watch a video. We are solving the problem of people looking to a small screen, since they can enjoy the mobile entertainment to the fullest, And this will allow business people to be able to make presentations on the fly. This also people enjoy taking picture using their cell phones and what is the use of having a picture that need to be uploaded to a laptop in order to see a bigger size of it. People now using the projector phone do not have to carry the laptop and a project and take with them everywhere they go, all they need to carry is the projector phone anywhere they go. Impromptu presentation.

The phone is dual sim card phone and is compatible with Quad Band and can be used anywhere in the work. The phone has two sim cards slots since now you can have two accounts one for business and for personal solving the problem of people carrying two phones around. Also allowing having two carriers phone on the same phone. We also have a FM antenna for people to watch Analog TV or listen to FM radio where the services are available. The phone also has a microSD card slot where people can load a microSD card. Where people can upload content to the phone or save from the phone to the card.

The phone has two cameras a front camera and a back camera allowing people to record videos with sound and save them to be projected later. The front camera can be used for video conferences. Or as a web camera and attached to a computer. The phone also has touch screen to help with an easy to use interface design. For people being able to touch the icons on the screen to access the content inside the phone. The phones's keypad has backlighting so people can be able to see the buttons in a dark room. The phone use a mini usb port which is a global standard to connect the phone or to a computer device, i.e. Ipod, DVD Players, Game Consoles. Software can change the projector from normal screen to wide screen with one click of a button. The phone is small enough to be carried by a regular carrying case using the belt of the carrier.

We are using a very economical processor with amazing processing capabilities in its price range GPRS 12, best cost effective processor for a media phone, it has an excellent GPRS throught and excellent power conservation and is very stable with Operating Systems, Lynux and C based operating systems. And will work with any Operating system. The keyboard is an easy to use number pad keyboard and has talk buttons for projection and has hot buttons to interact with display screen. The keyboard has a joypad for easy navigation within the screen and while the phone is in projection mode. During a projection session if a call comes in it will be visible on the screen or the projection.

The phone uses a 1200 mAH battery that with a full charge can give 2 to 3 hrs of talk time and up to 1.5 to 2 hours of projection time.

Examples of LCD projectors are described in the following documents:

U.S. Pat. No. 5,012,274 which was issued to Dolgoff on Apr. 30, 1991, described an active matrix LCD light valve between crossed polarizers, utilizing individual transistors to control each “pixel area” of the LCD and storage elements to store signal data for each pixel, with optically shielded “dead spaces” between pixels to eliminate electric field crosstalk.

U.S. Pat. No. 5,122,870 which was issued to Takeda on Jun. 16, 1992 described projection type liquid crystal color display apparatus has three liquid crystal display panels which are the same in structure.

U.S. Pat. No. 4,973,154, which was issued to Miyatake on Jul. 24, 1990 described projection display apparatus has a light source, a component color separator, a light transmitter(s), three light valves, a light combiner, a single projection lens, and a drive circuit.

U.S. Pat. No. 5,233,338, which was issued to Nguyen on Aug. 3, 1993 described a color sequential liquid crystal display, such as a television display, includes a lattice of selectably settable pixel elements which are time multiplexed addressed and illuminated during addressing to produce sequential red green and blue light outputs in any display period.

U.S. Pat. No. 5,847,748. which was issued to Laughlin on Dec. 8, 1998 described A multimedia projection system which includes a notebook computer and an integral projector. The system includes a base portion containing a central processing unit and a user input device, such as a keyboard.

U.S. Pat. No. 5,905,540 which was issued to Miyashita on May 18, 1999 described a projection-type video display in which the entire input video signal is first digitally corrected through digital gamma correction. Then, a subset of the corrected video signal is corrected again through analogue correction techniques.

U.S. Pat. No. 6,774,868 which was issued to Bowen on Aug. 10, 2004 described a method for tiling multiple displays to generate a large area display of moving data. Specifically, one embodiment of the present invention includes a system for generating a large area display of moving data.

U.S. Pat. No. 7,161,573 which was issued to Takatori on Jan. 9, 2007 described a method for driving a liquid crystal display apparatus in which in each field, scan lines are successively scanned in order to display an image, the scanning sequence or the polarity of a signal voltage is reversed between a first field and a second field.

U.S. Pat. No. 4,904,061, which was issued to Aruga on Feb. 27, 1990 described a projection-type display device for producing a faithful colored synthesized image based on equating the luminous intensity distributions and light patterns produced by three twisted nematic liquid crystal light valves for three primary color images.

### SUMMARY

In light of the advancements in the telephony industry and in the cell phone industry, The cell phone services in United States are run by large carrier corporations such as Verizon, Sprint, AT&T and T-Mobile which together comprise over 95% of the market share. In turn, customers are forced into long term contracts and offered out dated phones into the U.S. market compared to what is available in Asia and Europe. New technology enters the market at a very slow pace so carriers can eliminate the large stocks of phones that they buy through Nokia, HTC, LG, Apple, Samsung etc.

Our method is smart projector phones that are quad band and openly compatible with AT&T, T-Mobile, or any other GSM provider worldwide. We seek to take advantage of the technology lag between what is offered in the U.S. and what is currently available overseas.

Advantages:

New energy-efficient Smart Phones with built in pico (pocket) projectors

Quad band GSM technology that makes the phone useable on frequencies worldwide and compatible with any GSM company.

This document will describe the method for a cellular phone with content projector and is designed using readily available products. Including projection Analog TV thri-band (quad-band available),remind light, MOTION SENSOR Simulation game joypad two CAMERA dual sim card dual standby MP3/MP4 RMVB display BT FM voice time awake Digital Photo Album voice note. The method is comprised of front camera 2 MP and a back camera 3 MP, SIM Card Slot 1 and SIM Card Slot 2, projector TBA TBA, mini usb port, FM radio antenna—GSM, PIFA, Micro SD card slot, touch screen display, keypad row 4 line 3, 11 function keypad, processor, speaker 2 pcs. D20, microphone, battery 1200 mAh, PCB—printed circuit board, backlight for keypad. This method would also work with only one SIM card and with CDMA network where no SIM cards slots are used and it could project content on phone through wireless data. For example it could stream Youtube videos.

### DRAWINGS

### Figures

The method for a phone with content projector is described by the appended claims in relation to the description of a preferred embodiment with reference to the following drawings which are described briefly as follows:

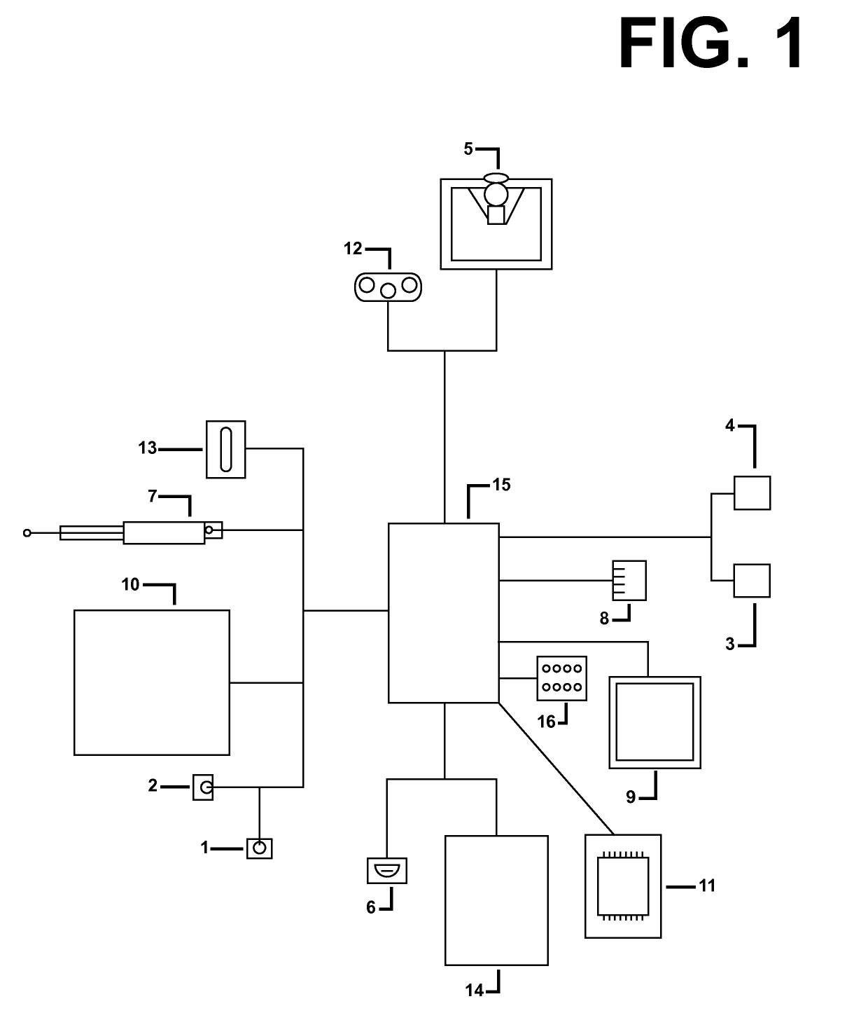

FIG. 1 is the electrical diagram of the method;

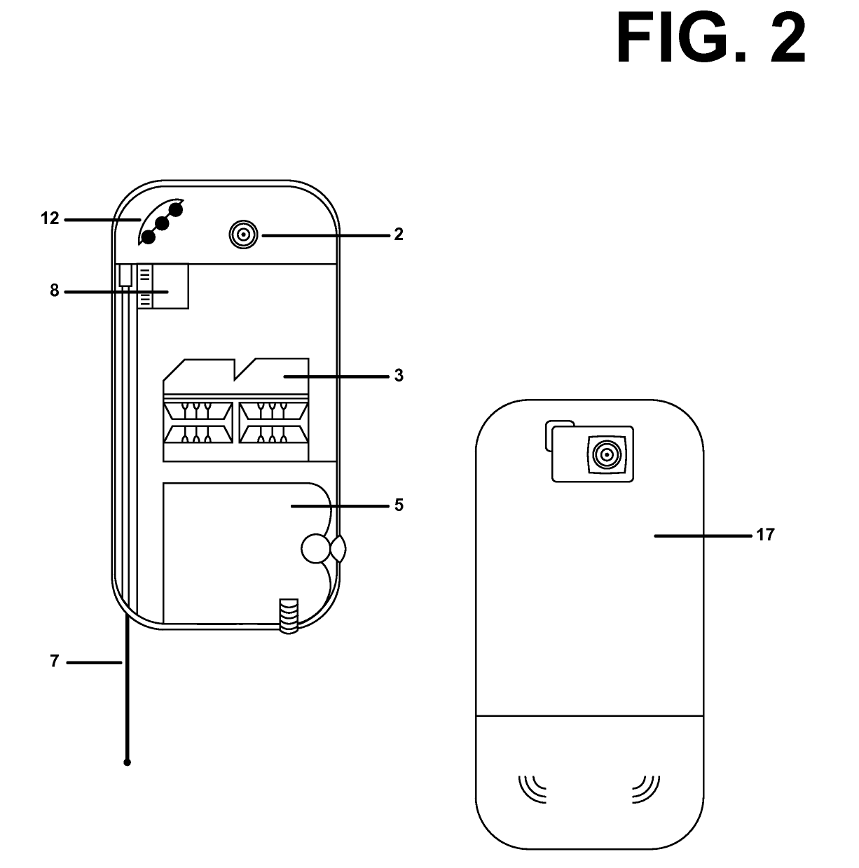

FIG. 2 is shows the back side of the phone;

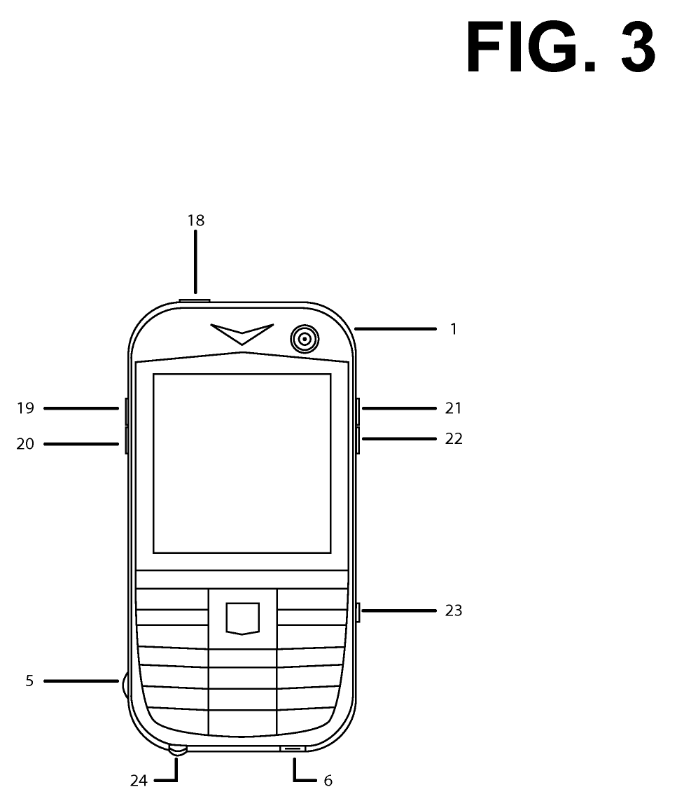

FIG. 3 is shows the front side of the phone.

### DETAILED DESCRIPTION

### FIGS. 1, 2 AND 3

### First Embodiment

Reference is made to FIG. 1 where we can see Front Camera 1 and Back Camera 2, connected to the Printed Circuit Board (PCB) 15, SIM Card Slot 1 and SIM Card Slot 2 also connected to the PCB 15, liquid crystal on silicon (LCOS) projector 5 mini USB port 6, FM Radio Antenna 7, Micro SD Card Slot 8, touch screen display 9, keypad 10, processor 11, speaker 12, microphone 13, battery 14 and back light for keypad 16. All components connect in the central point PCB 15.

In FIG. 2, we can see the Back Camera 2, speaker 12, micro SD slot 8 dual SIM card slot 3, liquid crystal on silicon (LCOS) projector 5 and antenna 7.

In FIG. 3, we can see the phone ON/OFF button 18, Front Camera 1 which also works as a webcam when mini USB connected, Scroll Up button 21 and Scroll Down button 22, Camera ON/OFF button 23, mini USB/charger port 6, Scroll Volume Up control 19, Scroll Volume Up 20, liquid crystal on silicon (LCOS) projector 5.

We claim:

1) This cell phone can project content from the phone's internal memory, storage devices such as microSD, stream wireless video content and also can be connected to an external device and project the external device content comprising:
a) None, one or more SIM cards; phone works;
b) a battery;
c) a microSD card slot;
d) a 2 MP camera;
e) a 3 MP camera;
f) FM radio antenna;

2) The phone as in claim 1 that projects content form inside the phone, GSM, and data from the GSM network;

3) The method as in claim 1 and how a laptop with a WIFI capability can connect to the phone and project images from the laptop on the phone projector;

4) The method as in claim 1 and how another regular phone with WIFI can connect to it to project the contents of the regular phone;

5) The method as in claim 1 and the software used to play the video content using the phone's projector;

6) The method as in claim 1 and the operational system that will switch between the phone screen as main output device and the phone projector as an output device;

7) This method presents a cell phone that has two SIM cards and two cameras which will allow:
a) Having two SIM cards will allow the phone to work simultaneously with two networks;
b) Two cameras will allow for video conferencing;

8) This method can download applications from the application network through the server
